(19) United States
(12) Patent Application Publication
(10) Pub. No.: US 2026/0168835 A1
(43) Pub. Date: Jun. 18, 2026

(54) MASS GAUGE MEASUREMENT DEVICE VIA FIBER BRAGG GRATINGS BASED ON CORIOLIS EFFECT

(71) Applicants: Allen Parker, JR., Lancaster, CA (US); Hon Man Chan, Santa Clarita, CA (US); Jonathan Lopez-Zepeda, Lancaster, CA (US); Sean M. Kenny, Huntsville, CA (US)

(72) Inventors: Allen Parker, JR., Lancaster, CA (US); Hon Man Chan, Santa Clarita, CA (US); Jonathan Lopez-Zepeda, Lancaster, CA (US); Sean M. Kenny, Huntsville, CA (US)

(21) Appl. No.: 18/985,579

(22) Filed: Dec. 18, 2024

(51) Int. Cl. G01F 1/84; G01N 9/32

(52) U.S. Cl. CPC G01F 1/8427; G01F 1/8422; G01F 1/8472; G01N 9/32

(57) ABSTRACT

Methods, systems, and devices are provided for measuring fluid transfer for fluid mass gauging using a fiber-optic sensor flowmeters based on Coriolis effect. Aspects include a Coriolis mass flowmeter using fiber-optic sensor elements that may measure the mass flow rate without directly interacting with the fluid under measurement is provided. Various aspects may include flowmeters suitable for cryogenic fluid mass gauging that use Fiber Bragg grating based fiber-optic sensors.

### CROSS-REFERENCE TO RELATED PATENT APPLICATION(S)

This patent application claims the benefit of and priority to U.S. Provisional Application No. 63/611,921, filed on Dec. 19, 2023, the contents of which are hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Cryogenic fluids, also known as cryogens, and cryogenic fluid technologies are critical to the development of new space exploration capabilities, such as new space flight propulsion technologies, cooling technologies, etc. One challenge faced in cryogenic systems, especially cryogenic systems for space flight, is the need to reliably measure the flow rate of cryogenic fluid. Current methods for measuring cryogenic fluid transfer do not ensure accuracy or reliability necessary for fluid mass gauging.

One example current approach to mass gauging is the use of a mechanical paddle wheel. Mechanical paddle wheels are invasive to the flow level and often incompatible with cryogenic fluids. Additionally, paddle wheels have a relative accuracy of +/−5% that is not suitable for many applications.

Another example of a current approach to mass gauging is the use of ultrasonic detection. Such fluid flow sensor systems utilize ultrasonic wave excitation, where a pair of piezoelectric transducers (PZTs) are installed on opposite sidewalls of a pipe, where the transmission/reflection rate will be uniform for a pipe with no fluid flow. If fluid is flowing in the pipe, the transmission and reflection rate from the ultrasonic wave will be either faster or slower, thus a flow rate can then be calculated. However, tracking flow rate with ultrasonic reflection can be problematic as depending on the density of the fluid, the transmission velocity can change, even at the same flow rate. Thus, the ultrasonic detection approaches suffer from needing to be recalibrated depending on the characteristics of the fluid flow. Also, for a moving vehicle, such as during rocket launch, there can be many different vibrations that can interfere with reflected waves, increasing uncertainty or loss of measurement.

More advanced fluid sensor approaches have used the effect of resistive heating, whereby the level of fluid flow affects the cooling level of the heating material. This method will not work for cryogens as the resistive heating leads to undesirable boil-off of the cryogenic fluid.

As the current fluid sensor approaches face challenges in usage for cryogenic fluid mass gauging, a method for measuring cryogenic fluid transfer that ensures the accuracy and/or reliability necessary for fluid mass gauging would be beneficial, especially to the development of new space exploration capabilities.

### BRIEF SUMMARY OF THE INVENTION

Various embodiments may provide methods, systems, and devices for measuring fluid transfer for fluid mass gauging using a fiber-optic sensor flowmeter based on the Coriolis effect. Various embodiments may provide methods, systems, and devices for measuring cryogenic fluid transfer for fluid mass gauging using a fiber-optic sensor flowmeter based on the Coriolis effect. Various embodiments may provide a Coriolis mass flowmeter using fiber-optic sensor elements that may measure the mass flow rate without directly interacting with the fluid under measurement. Various embodiments may include flowmeters suitable for cryogenic fluid mass gauging that use Fiber Bragg grating based fiber-optic sensors.

One embodiment may be a mass flowmeter, comprising: a length of tube having an inlet opening and an outlet opening; a first fiber-optic sensor having a first sensing element affixed to the length of tube between the inlet opening and the outlet opening; a second fiber-optic sensor having a second sensing element affixed to the length of tube between the first fiber-optic sensor and the outlet opening; and a drive element configured to interact with the length of tube between the first sensing element and second sensing element to induce a vibration into the length of tube.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a component block diagram of a mass flowmeter in accordance with various embodiments.

FIG. 2 is a process flow diagram illustrating a method for determining mass flow rate in accordance with the various embodiments.

FIG. 3 is a block diagram of a set-up of a testing system in which a mass flowmeter in accordance with various embodiments and an ultrasonic flow meter were placed in line with one another to test and validate the operation of the mass flowmeter in accordance with various embodiments.

FIGS. 4-6 are each graphs of results of wavelength shift measurements over time of flow and without flow states of the testing system illustrated in FIG. 3 at different frequencies.

FIG. 7 illustrates graphs of flow rate correlation data at different frequencies from the testing system illustrated in FIG. 3.

### DETAILED DESCRIPTION OF THE INVENTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention.

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Cryogenic fluids include those fluids that have a boiling point below 120 Kelvin (K), such as hydrogen, helium, nitrogen, etc. In cryogenic systems, cryogenic fluids are often stored, circulated, and/or otherwise used in their liquid states at certain times and/or in certain parts of the systems. However, cryogenic systems may include systems in which cryogenic fluids are partially and/or entirely present in their gaseous states. Cryogenic systems, especially cryogenic systems for space flight, are in need of methods for measuring cryogenic fluid transfer that provide accuracy and/or reliability for fluid mass gauging.

A Coriolis mass flowmeter may be a flowmeter that may be configured to measure the mass flow rate without directly interacting with the fluid under measure. A Coriolis mass flowmeter may be used on most types of liquids and gases. A Coriolis mass flowmeter may measure the fluid's density, viscosity, and/or temperature. When there is no fluid flow, a vibrating tube vibrates uniformly. When fluid is flowing in the tube, a time delay occurs at each end of the tube. The time delay can be measured to calculate the flow rate. The resonance frequency of the tube with fluid can be measured to calculate the fluid density.

In a typical Coriolis flowmeter, the measurement tube is fabricated via a U-shaped curve, where there is an inlet (downward) slope, a straight part, as well as an outlet (upward) slope. The main principle of the Coriolis flowmeter is the presence of a constant, resonant vibration on the U-shape tubing. The oscillation of the tubing adds an additional angular momentum portion to the mass flow rate of the fluid through the tubing, which results in a twisting (or deflection) motion of the outlet flow.

The Coriolis force (Fc) is determined by the equation, Fc=2*m (ω*V), where m=mass [kg], ω=angular velocity due to resonant frequency [rad/s], and V=velocity of the flow [m/s].

For a typical Coriolis flowmeter, the phase difference of vibration between the inlet and the outlet is measured either from another pair of receiving piezoelectric disks, or a pair of magnetic sensors, measuring twisting of the pipe. Temperature compensation needs to occur to offset contraction of the pipes, which is performed via a separate RTD (resistive thermal diode). Depending on the density of the flow, the oscillation frequency of both inlet and outlet flow can also be affected, where the lower density material has higher oscillation frequency, and vice versa due to the force of the fluid flow rate.

Current mass flow rate sensors based on the Coriolis effect are available in the marketplace. In such current Coriolis flowmeters, by adding a y-axis vibrating force on the x-axis flow, an angular momentum component is added into the outward flow of the pipe, which causes the pipe to twist. By monitoring the twist rate phase-difference, via magnetic sensors, on both the inward and outward flow of the pipe, the difference in twist rate is directly proportional to the mass of the fluid. This is an advantage of the Coriolis flowmeter as the Coriolis flowmeter is directly measuring mass flow rate, without any need to calibrate for viscosity or type of fluid. Current Coriolis flowmeters utilize magnetic sensors. A drawback to current Coriolis flowmeters is that tiny magnetic force changes can cause errors in the measurements of the Coriolis flowmeters. Therefore, current Coriolis flowmeter setups need bulky electromagnetic interference (EMI) shielding to the U-shaped piping in order to make sure measurements will be accurate. Also, by changing to a bigger pipe size to increase flow rate, the amount of the outward pipe's twisting could be reduced, that could affect the sensitivity of the measurement. Due to these and other drawbacks, current Coriolis flowmeter designs using piezoelectric disks and/or magnetic sensors face challenges in usage for cryogenic fluid mass gauging, especially for use in cryogenic systems used in space exploration.

Various embodiments may provide methods, systems, and devices for measuring fluid transfer for fluid mass gauging using a fiber-optic sensor flowmeter based on Coriolis effect. Various embodiments may provide methods, systems, and devices for measuring cryogenic fluid transfer for fluid mass gauging using a fiber-optic sensor flowmeter based on Coriolis effect. Various embodiments may provide a Coriolis mass flowmeter using fiber-optic sensor elements that may measure the mass flow rate without directly interacting with the fluid under measurement. Various embodiments may include flowmeters suitable for cryogenic fluid mass gauging that use Fiber Bragg grating based fiber-optic sensors. A flowmeter based on Coriolis effect in accordance with various embodiments may have the advantage of being very accurate, as it can measure both the mass flow and the density of the fluid, via the phase-difference of the output flow, caused by the additional angular momentum due to the Coriolis effect. Various embodiments may use Fiber Bragg grating based fiber-optic sensors to measure a twisting difference between an input and output pipe, thereby enabling a mass flow rate to be measured. Various embodiments may use Fiber Bragg grating based fiber-optic sensors to monitor the periodicity of the twisting, which then may correlate to a density of the fluid.

Various embodiments are described herein as using fiber-optic sensors. As used herein, a fiber-optic sensor may be a sensing device that uses one or more optical fiber at least in part as the sensing element. One type of such fiber-optic sensor may be a Fiber Bragg grating based fiber-optic sensor, or Fiber Bragg grating (FBG) sensor for short, that uses a FBG constructed in a length of optical fiber at least in part as the sensing element.

Using fiber-optic based sensing systems to measure the time delay and the resonate frequency to in a Coriolis mass flowmeter may provide benefits including: making the flowmeter resistant to EMI; having a faster sampling rate; having a higher sensitivity for measuring low flow rate, and making the use of straight line measurement feasible.

In various embodiments, instead of utilizing piezoelectric disks or magnetic sensors to measure twisting difference between the inlet and outlet flow, FBGs may be bonded within the tubes to directly measure the amount of twisting motion. Because twisting motion of the inlet and outlet pipe are measured directly via FBGs, the results should be more accurate than deflection measurement via piezoelectric or magnetic sensors.

In various embodiments, to measure the twisting motion, the FBG sensor may be bonded at a 45 degree angle from the length of the pipe, to maximize the twisting motion at a particular direction. Using the principle of measuring the phase difference between the twisting motion from the inlet and outlet flow, the mass flow rate can be calculated. Instead of measuring complex three-dimensional (3D) shape of the pipe during flow, a simple 45 degree orientation of the FBG can detect twisting motion parallel to the direction of the fiber, where the strain amplitude may be sinusoidal relative to the resonant vibration of the pipe. By comparing the phase differences in amplitude from the inlet and outlet pipe, the mass flow rate may be calculated. Density of the fluid may be measurable via the frequency of the amplitude. Also directly measuring twisting of the pipe may increase mass gauge sensitivity, and since FBG is sensitive to both temperature and strain (twisting) motion, another separate FBG may replace the on-board RTD in order to compensate for temperature changes resulting from cryogenic flow. In other embodiments, rather than being bonded at a 45 degree angle from the length of the pipe, the FBG sensor may be bonded in parallel to the pipe flow direction.

Fiber-optic sensor flowmeters based on Coriolis effect in accordance with the various embodiments may provide various benefits in comparison to current flowmeters, including that embodiment fiber-optic sensor flowmeters may be natively immune to EMI, that embodiment fiber-optic sensor flowmeters may have added sensitivity in comparison to current flowmeters, and that embodiment fiber-optic sensor flowmeters may have a reduced size and complexity in comparison to current flowmeters. Fiber-optic sensor flowmeters based on Coriolis effect in accordance with the various embodiments may have benefits to the National Aeronautics and Space Administration (NASA) applications, specifically the Space Technology Mission Directorate's (STMD's) cryogenic fluid management portfolio project (CFMPP) as the fiber-optic sensor flowmeters based on Coriolis effect in accordance with the various embodiments may provide accurate mass gauging for in-space fluid transport. Fiber-optic sensor flowmeters based on Coriolis effect in accordance with the various embodiments may also support measuring other cryogenics, such as liquid hydrogen, that may support future propellent system that would reduce carbon dioxide (CO₂) emissions. Fiber-optic sensor flowmeters based on Coriolis effect in accordance with the various embodiments may also be beneficial in any other field, such as oil and gas, food production, etc., that needs accurate mass gauging.

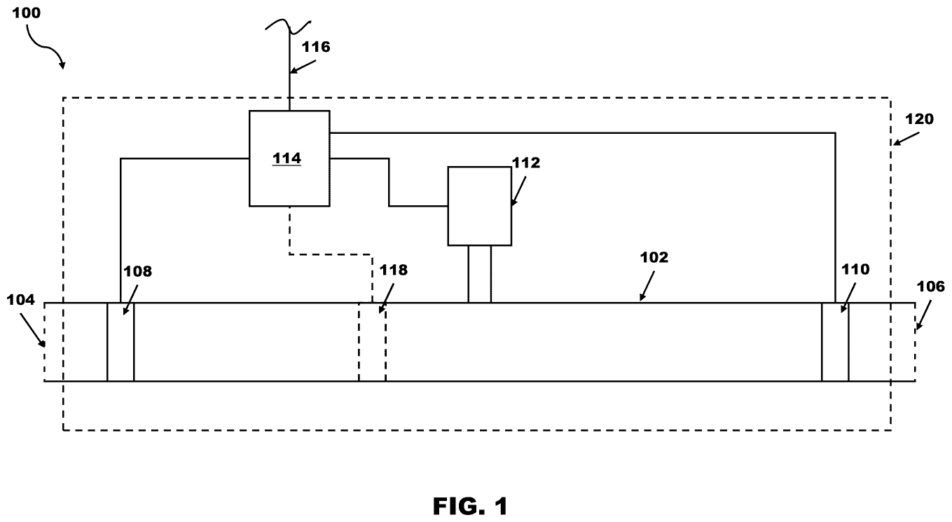

FIG. 1 is a component block diagram of a mass flowmeter 100 in accordance with various embodiments. The mass flowmeter 100 may be a fiber-optic sensor flowmeter configured for measuring fluid transfer for fluid mass gauging based on the Coriolis effect. The mass flowmeter 100 may be suitable for measuring cryogenic fluid transfer. The mass flowmeter 100 may measure the mass flow rate without directly interacting with the fluid under measurement.

The mass flowmeter 100 may include a length of tube 102. The length of tube 102 may have an inlet opening 104 at one end and an outlet opening 106 at another end. The inlet opening 104 may be configured to receive a fluid flow, such as a cryogenic fluid flow. The fluid flow may travel through the length of tube 102 to outlet opening 106 and out of the length of tube 102. When installed in a fluid system, such as a cryogenic system, the mass flowmeter may be installed in a fluid transfer system to measure the mass flow rate and/or density of the fluid in the length of tube 102. The length of tube 102 may be a straight length of tube 102 between the inlet opening 104 and the outlet opening 106. In other embodiments, the length of tube 102 may be a curved length of tube. The length of tube 102 may be configured to have cryogenic fluid flowing therein. Alternatively, or additionally, the length of tube 102 may be configured to have fluid other than cryogenic fluid flowing therein.

The mass flowmeter 100 may include a first fiber-optic sensor 108 having a first sensing element affixed to the length of tube 102. For example, the first fiber-optic sensor 108 may be bonded to the length of tube 102. In some embodiments, the first fiber-optic sensor 108 may be a first FBG sensor. The first fiber-optic sensor 108 may be connected to a control unit 114. The control unit 114 may be a controller, processor, or other type device configured with hardware and/or software to receive signal data, control the operation of the mass flowmeter, and determine mass flow rate based on the Coriolis effect. The first fiber-optic sensor 108 may be configured to output signal data to the control unit 114 and the control unit 114 may be configured to receive signal data from the first fiber-optic sensor 108.

The mass flowmeter 100 may include a second fiber-optic sensor 110 having a second sensing element affixed to the length of tube 102. For example, the second fiber-optic sensor 110 may be bonded to the length of tube 102. In some embodiments, the second fiber-optic sensor 110 may be a second FBG sensor. The second fiber-optic sensor 110 may be connected to the control unit 114. The second fiber-optic sensor 110 may be configured to output signal data to the control unit 114 and the control unit 114 may be configured to receive signal data from the second fiber-optic sensor 110.

The first sensing element of the first fiber-optic sensor 108 may be affixed to the length of tube 102 between the inlet opening 104 and the outlet opening 106. The second sensing element of the second fiber-optic sensor 110 may be affixed to the length of tube 102 between the first fiber-optic sensor 108 and the outlet opening 106. In some embodiments, the first fiber-optic sensor 108 and the second fiber-optic sensor 110 may each be affixed to the length of tube 102 forty-five degrees offset from a central axis of the length of tube 102. In some embodiments, the first fiber-optic sensor 108 and the second fiber-optic sensor 110 may each be affixed to the length of tube 102 parallel to the flow direction through the length of tube 102.

The mass flowmeter 100 may include a drive element 112 configured to interact with the length of tube 102 between the first sensing element and second sensing element to induce a vibration into the length of tube 102. The drive element 112 may be a mechanical shaker, mechanical actuator, or other type mechanical device configured to impart a vibration into the length of tube 102. Similarly, the drive element 112 may be driven by a piezo-electric actuator or other electrical actuator configured to impart a vibration into the length of tube 102. The drive element 112 may be connected to the control unit 114. The control unit 114 may be configured to control the drive element 112 to induce a vibration into the length of tube 102 at a selected frequency. For example, the selected frequency may be 40 Hertz (Hz), 50 Hz, 75 Hz, 100 Hz, etc.

The control unit 114 may be configured to determine a mass flow rate based at least in part on received signal data from the first fiber-optic sensor 108 and the second fiber-optic sensor 110. The control unit 114 may be configured to determine a density based at least in part on received signal data from the first fiber-optic sensor 108 and the second fiber-optic sensor 110. The control unit 114 may be configured to output an indication of the determined mass flow rate and/or an indication of the determined density. For example, the indications may be sent via a data cable connection 116 to another device, such as a cryogenic system controller and/or output via connection 116 to a display or other type user interface. The control unit 114 may include additional elements therein, such as one or more power supplies, etc. The control unit 114 may be configured to receive inputs/signals, execute determinations, output indications/signals, control other devices, compensate and/or adjust determinations/calculations, and/or perform other operations through hardware components, software instructions, and a combination thereof.

The mass flowmeter 100 may optionally include a housing 120 encasing all or some of the parts of the mass flowmeter 100.

The mass flowmeter 100 may optionally include a third fiber-optic sensor 118 having a third sensing element affixed to the length of tube 102. For example, the third fiber-optic sensor 118 may be bonded to the length of tube 102. In some embodiments, the third fiber-optic sensor 118 may be a third FBG sensor. The third fiber-optic sensor 118 may be connected to the control unit 114. The third fiber-optic sensor 118 may be configured to output signal data to the control unit 114 and the control unit 114 may be configured to receive signal data from the third fiber-optic sensor 118. The control unit 114 may be configured to determine a temperature of the length of tube 102 based on the received signal data from the third fiber-optic sensor 118 and compensate for contraction in the length of tube 102 in determining the mass flow rate and the density based at least in part on the temperature.

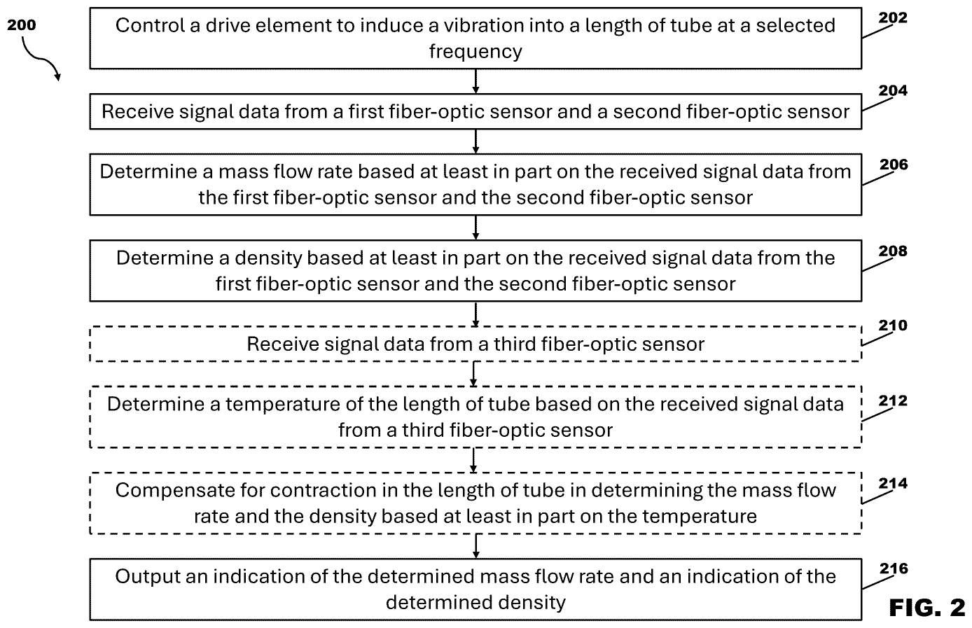

FIG. 2 is a process flow diagram illustrating a method 200 for determining mass flow rate in accordance with the various embodiments. In various embodiments, the operations of method 200 may be formed by a control unit of a mass flowmeter, such as control unit 114 of mass flowmeter 100. In various embodiments, the operations of method 200 may be useful for determining mass flow rate of a fluid, such as a cryogenic fluid.

In block 202, the control unit may control the drive element to induce the vibration into the length of tube at a selected frequency. For example, the control unit may send an actuation signal to the drive element to induce the vibration. For example, the selected frequency may be 40 Hz, 50 Hz, 75 Hz, 100 Hz, etc.

In block 204, the control unit may receive signal data from the first fiber-optic sensor and the second fiber-optic sensor. The received signal data may be measurements of twisting motion of the length of tube 102. For example, the received signal data may be measurements of strain as sensed at the first fiber-optic sensor 108 and the second fiber-optic sensor 110.

In block 206, the control unit may determine a mass flow rate based at least in part on the received signal data from the first fiber-optic sensor and the second fiber-optic sensor. For example, the control unit may determine amplitude and frequency of the received signal data and determine a phase shift between the waveforms of the signal data from the first fiber-optic sensor and the signal data from the second fiber-optic sensor. The phase shift data may be determined using fast Fourier transform (FFT) and by comparing the phase differences in amplitude from the inlet and outlet pipe, the mass flow rate may be calculated.

In block 208, the control unit may determine a density based at least in part on the received signal data from the first fiber-optic sensor and the second fiber-optic sensor. For example, density of the fluid may be measurable via the frequency of the amplitude.

In optional block 210, the control unit may receive signal data from the third fiber-optic sensor. The third fiber-optic sensor may be optionally present in some embodiment mass flow meters.

In optional block 212, the control unit may determine a temperature of the length of tube based on the received signal data from the third fiber-optic sensor. Directly measuring twisting of the pipe may increase mass gauge sensitivity, and since fiber-optic sensors are sensitive to both temperature and strain (twisting) motion, the third fiber-optic sensor may replace the on-board RTD in order to compensate for temperature changes from cryogenic flow.

In optional block 214, the control unit may compensate for contraction in the length of tube in determining the mass flow rate and the density based at least in part on the temperature.

Blocks 210-214 may be optional, as a third fiber-optic sensor replacing the need for a RTD may not be present in all embodiments.

In block 215, the control unit may output an indication of the determined mass flow rate and an indication of the determined density. For example, the indications may be sent via a data cable connection 116 to another device, such as a cryogenic system controller and/or output via connection 116 to a display or other type user interface.

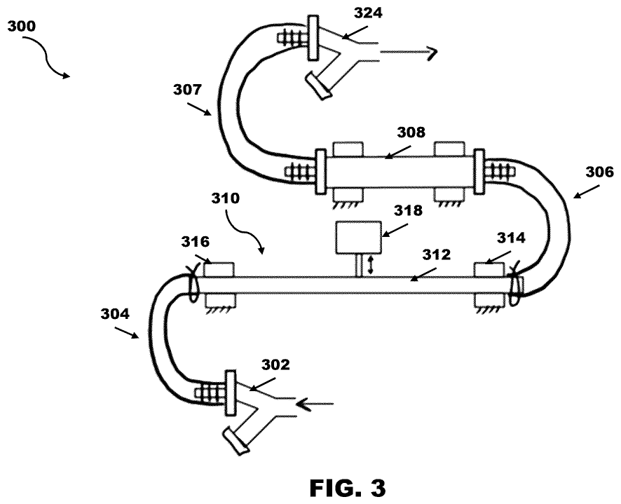

FIG. 3 is a block diagram of a set-up of a testing system 300 in which a mass flowmeter 310 in accordance with various embodiments and an ultrasonic flow meter 308 were placed in line with one another to test and validate the operation of the mass flowmeter 310 in accordance with various embodiments. The testing system 300 included a Y-spliter 302 receiving fluid flow in, a curved tube 304 routing the fluid to the inlet of flow meter 308. A curved tube 306 routing the outlet flow to the ultrasonic flow meter 308, and a curved tub 307 routing the fluid to a Y-spliter 324. The mass flowmeter 310 is a fiber-optic mass flowmeter similar to mass flowmeter 100 in FIG. 1 and includes a fiber-optic sensor 316 and fiber-optic sensor 314. Additionally, the mass flowmeter 310 includes mechanical shaker 318 configured to induce vibration on the length of tube 312 of the mass flowmeter 310. In the testing performed, the length of tube 312 was a ⅜ inch diameter stainless steel tube. The ultrasonic flow meter 308 was attached to a 1 inch diameter pipe. The fiber-optic sensors 314 and 316 were FBG sensors.

Testing was performed using the testing system 300 to observe changing vibration rate to compare phase change of the inlet vs outlet FBGs from a constant liquid flow rate. Testing was performed using the testing system 300 to observe keeping constant the vibration rate, and changing the water flow rate to determine the flow rate via the phase difference of the FBG sensors.

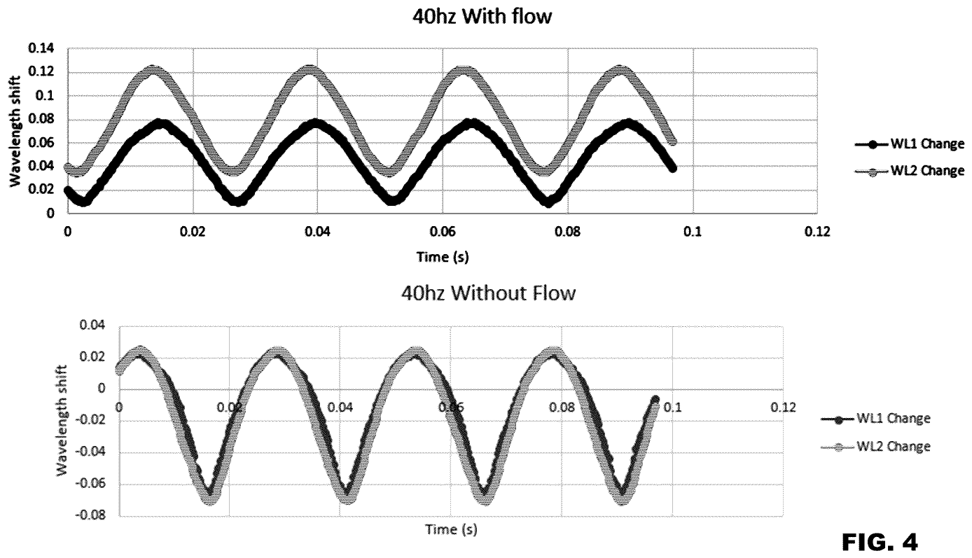

FIGS. 4-6 are each graphs of results of wavelength shift measurements over time of flow and without flow states of the testing system illustrated in FIG. 3 at different frequencies. FIG. 4 illustrates 40 Hz vibration with flow in the upper graph and without flow in the lower graph. The phase shift in the with flow data was found to be 0.2217. The phase shift in the without flow data was found to be 0.04095.

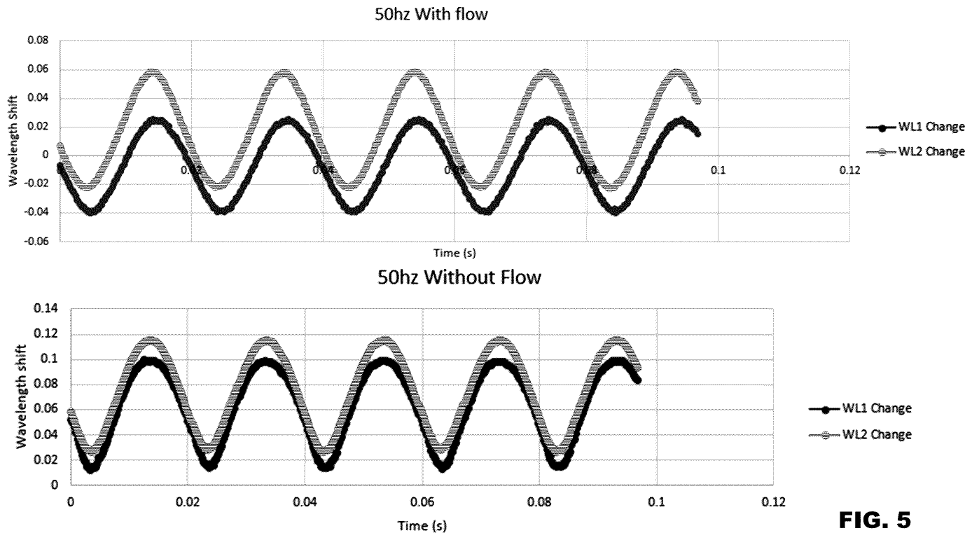

FIG. 5 illustrates 50 Hz vibration with flow in the upper graph and without flow in the lower graph. The phase shift in the with flow data was found to be 0.2146. The phase shift in the without flow data was found to be 0.0484.

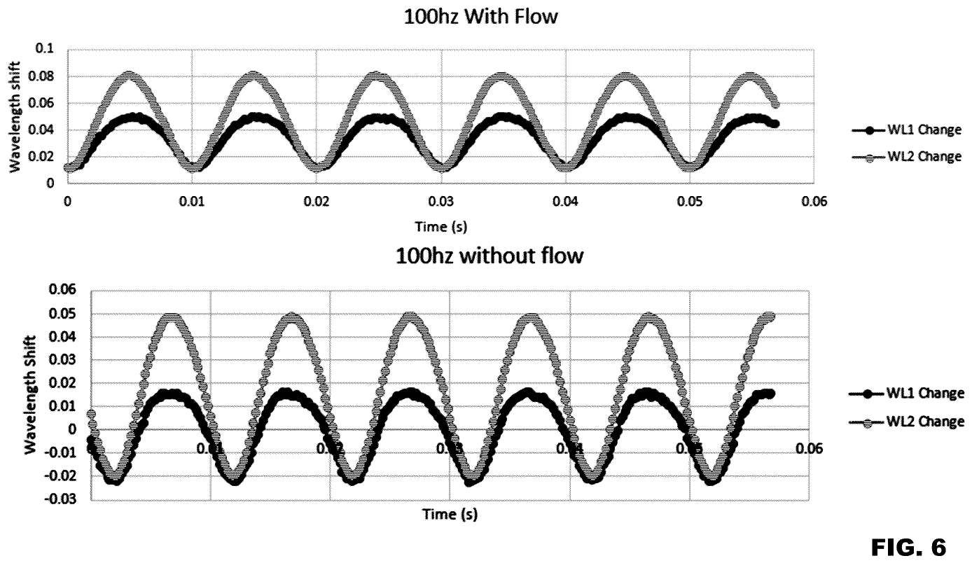

FIG. 6 illustrates 100 Hz vibration with flow in the upper graph and without flow in the lower graph. The phase shift in the with flow data was found to be 0.1638. The phase shift in the without flow data was found to be 0.017747.

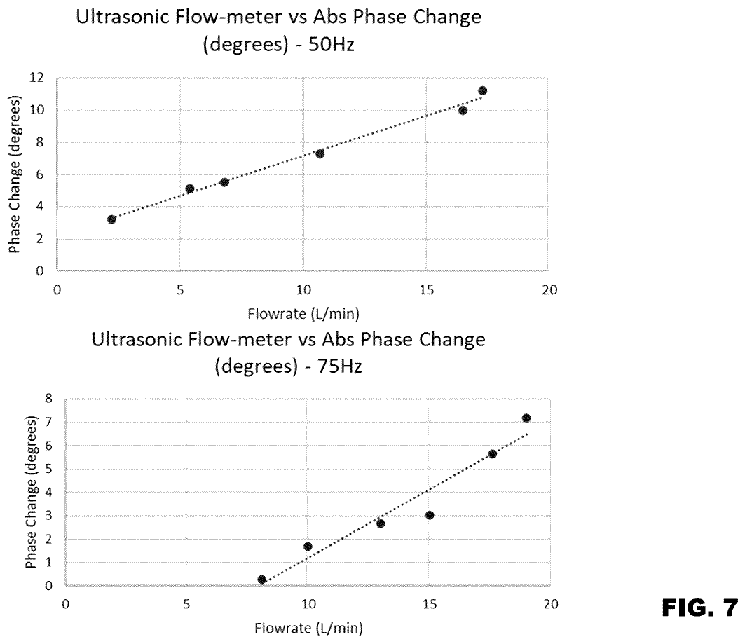

FIG. 7 illustrates graphs of flow rate correlation data at different frequencies, 50 Hz and 75 Hz, from the testing system illustrated in FIG. 3. The upper graph shows that at the 50 Hz vibration, as flow rate increases as measured by the ultrasonic flow meter 308, the phase shift increases. The lower graph shows that for the 75 Hz vibration, the linear relationship of the flow rate and phase change is also present.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

Any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A mass flowmeter, comprising:
a length of tube having an inlet opening and an outlet opening;
a first fiber-optic sensor having a first sensing element affixed to the length of tube between the inlet opening and the outlet opening;
a second fiber-optic sensor having a second sensing element affixed to the length of tube between the first fiber-optic sensor and the outlet opening; and
a drive element configured to interact with the length of tube between the first sensing element and second sensing element to induce a vibration into the length of tube.

2. The mass flowmeter of claim 1, wherein:
the first fiber-optic sensor is a first Fiber Bragg grating (FBG) sensor; and
the second fiber-optic sensor is a second FBG sensor.

3. The mass flowmeter of claim 2, wherein the drive element is a mechanical shaker.

4. The mass flowmeter of claim 2, wherein the drive element is a driven by a piezo-electric actuator.

5. The mass flowmeter of claim 2, wherein the length of tube is a curved length of tube.

6. The mass flowmeter of claim 2, wherein the length of tube is a straight length of tube between the inlet opening and the outlet opening.

7. The mass flowmeter of claim 2, wherein the first FBG sensor and the second FBG sensor are each affixed to the straight length of tube forty-five degrees offset from a central axis of the straight length of tube.

8. The mass flowmeter of claim 2, wherein the first FBG sensor and the second FBG sensor are each affixed to the straight length of tube parallel to a flow direction through the straight length of tube.

9. The mass flowmeter of claim 2, further comprising:
a control unit connected to the first FBG sensor, the second FBG sensor, and the drive element, wherein the control unit is configured to:
control the drive element to induce the vibration into the length of tube at a selected frequency;
receive signal data from the first FBG sensor and the second FBG sensor;
determine a mass flow rate based at least in part on the received signal data from the first FBG sensor and the second FBG sensor;
determine a density based at least in part on the received signal data from the first FBG sensor and the second FBG sensor; and
output an indication of the determined mass flow rate and an indication of the determined density.

10. The mass flowmeter of claim 9, further comprising:
a third FBG sensor affixed to the length of tube,
wherein:
the third FBG sensor is connected to the control unit; and
the control unit is further configured to:
receive signal data from the third FBG sensor;
determine a temperature of the length of tube based on the received signal data from the third FBG sensor; and
compensate for contraction in the length of tube in determining the mass flow rate and the density based at least in part on the temperature.

11. The mass flowmeter of claim 10, wherein the length of tube is configured to have cryogenic fluid flowing therein.

12. The mass flowmeter of claim 1, wherein the drive element is a mechanical shaker.

13. The mass flowmeter of claim 1, wherein the drive element is a driven by a piezo-electric actuator.

14. The mass flowmeter of claim 1, wherein the length of tube is a curved length of tube.

15. The mass flowmeter of claim 1, wherein the length of tube is a straight length of tube between the inlet opening and the outlet opening.

16. The mass flowmeter of claim 1, further comprising:
a control unit connected to the first fiber-optic sensor, the second fiber-optic sensor, and the drive element, wherein the control unit is configured to:
control the drive element to induce the vibration into the length of tube at a selected frequency;
receive signal data from the first fiber-optic sensor and the second fiber-optic sensor;
determine a mass flow rate based at least in part on the received signal data from the first fiber-optic sensor and the second fiber-optic sensor;
determine a density based at least in part on the received signal data from the first fiber-optic sensor and the second fiber-optic sensor; and
output an indication of the determined mass flow rate and an indication of the determined density.

17. The mass flowmeter of claim 16, further comprising:
a third fiber-optic sensor affixed to the length of tube,
wherein:
the third fiber-optic sensor is connected to the control unit; and
the control unit is further configured to:
receive signal data from the third fiber-optic sensor;
determine a temperature of the length of tube based on the received signal data from the third fiber-optic sensor; and
compensate for contraction in the length of tube in determining the mass flow rate and the density based at least in part on the temperature.

18. The mass flowmeter of claim 1, wherein the length of tube is configured to have cryogenic fluid flowing therein.
